(19) United States
(12) Patent Application Publication
(10) Pub. No.: US 2009/0055689 A1
(43) Pub. Date: Feb. 26, 2009

(54) SYSTEMS, METHODS, AND COMPUTER PRODUCTS FOR COORDINATED DISASTER RECOVERY

(75) Inventor: David B. Petersen, Great Falls, VA (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/842,287

(22) Filed: Aug. 21, 2007

(51) Int. Cl. G06F 11/30

(52) U.S. Cl. 714/47; 714/E11.179

(57) ABSTRACT

Systems, methods and computer products for coordinated disaster recovery of at least one computing cluster site are disclosed. According to exemplary embodiments, a disaster recovery system may include a computer processor and a disaster recovery process residing on the computer processor. The disaster recovery process may have instructions to monitor at least one computing cluster site, communicate monitoring events regarding the at least one computing cluster site with a second computing cluster site, generate alerts responsive to the monitoring events on the second computing cluster site regarding potential disasters, and coordinate recovery of the at least one computing cluster site onto the second computing cluster site in the event of a disaster.

### BACKGROUND OF THE INVENTION

1. Field of the Invention

This invention relates to disaster recovery and continuous availability (CA) of computer systems. Particularly, the invention relates to systems, methods, and computer products for coordinated disaster recovery and CA of at least one computing cluster site.

2. Description of Background

A computing cluster is a group of coupled computers or computing devices that work together in a controlled fashion. The components of a computing cluster are conventionally, but not always, connected to each other through local area networks, wide area networks, and/or communication channels. Computing clusters may be deployed to improve performance and/or resource availability over that provided by a single computer, while typically being more cost-effective than single computers of comparable speed or resources. In the event of a disaster, components of a computing cluster may be disabled, thereby disrupting operation of the computing cluster or disabling the cluster altogether. Disaster recovery and CA may provide a form of protection from disasters and shut-down of a computing cluster, by providing methods of allowing a second (or secondary) computing cluster, or a second group of units within the same cluster, to assume the tasks and priorities of the disabled computing cluster or portions thereof.

Conventionally, disaster recovery may include data replication from a primary system to a secondary system. For example, each of the primary system and the secondary system may be considered a computing cluster or alternatively, a single cluster including both the primary and secondary systems. The secondary system may be configured substantially similar to the primary system, and may receive data to be replicated from the primary system either through hardware or software. For example, hardware may be swapped or copied from the primary system onto the secondary system in a hardware implementation, or alternatively, software may direct information from the primary system to the secondary system in a software implementation.

If the secondary system stores an updated data replication of the primary system, conventional disaster recovery may include initiating the secondary system to run the updated replication of the primary system, and the primary system may be shut down. Therefore, the secondary system may take over the tasks and priorities of the primary system. It is noted that the primary and secondary systems should not be running or processing the replicated information concurrently. More specifically, the updated replication of the primary system may not be initiated if the primary system is not shut-down. Furthermore, conventional computing systems may include a plurality of components spanning multiple platforms and/or operating systems (e.g., an internet web application computing cluster may have web serving on server x, application serving on server y, and additional application serving & database serving on server z). Therefore, each individual component of a conventional system may be replicated separately, and each secondary component (for the purpose of disaster recovery) must be initiated separately given the multiple platforms and/or operating systems. It follows that, due to the separate initiation of separate components, there may be time lapse and/or uncoordinated boot-up times between portions of the secondary system. Such time discrepancies may inhibit proper operation of the secondary system.

For example, if the system being recovered includes three components, and those three components are recovered separately and at different times, each of the three components would be out of synchronization with one another, thereby harping performance of the recovered system. If the system is time sensitive, the newly booted secondary system may have to be reset or adjusted to resolve the discrepancies. For example, web serving on server x, application serving on server y, and additional application serving & database serving on server z may need to be re-synchronized such that the web serving, applications, and the like are in the same state. Time discrepancies between similar components may result in inoperability of the complete system.

Furthermore, some computing clusters may have a plurality of applications that may not span multiple platforms and/or operating systems. For example, a web server may include additional applications running on the web server which must be separately recovered from other applications on the web server. It can be appreciated that it may be difficult to coordinate initiation of several different platforms and/or operating systems for a conventional system to be recovered at a single point of reference. Therefore, system-wide disaster recovery may be difficult in conventional systems.

### SUMMARY OF THE INVENTION

The shortcomings of the prior art may be overcome and additional advantages may be provided through the provision of a disaster recovery system.

According to exemplary embodiments, a disaster recovery system may include a computer processor and a disaster recovery process residing on the computer processor. The disaster recovery process may have instructions to monitor at least one computing cluster site, communicate monitoring events regarding the at least one computing cluster site with a second computing cluster site, generate alerts responsive to the monitoring events on the second computing cluster site regarding potential disasters, coordinate recovery of the at least one computing cluster site onto the second computing cluster site in the event of a disaster.

According to exemplary embodiments, a method of disaster recovery of at least one computing cluster site may include receiving monitoring events regarding the at least one computing cluster site, generating alerts responsive to the monitoring events regarding potential disasters, and coordinating recovery of the at least one computing cluster site based on the alerts.

According to exemplary embodiments, a method of disaster recovery of at least one computing cluster site may include sending monitoring events regarding the at least one computing cluster site, transmitting data from the at least one computing cluster site for disaster recovery based on the monitoring events, and ceasing processing activities.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

In order to coordinate disaster recovery across multiple platforms and/or components of computing clusters, the inventor has discovered that a disaster recovery system, including a disaster recovery process, may be used to provide a centralized monitoring entity to maintain information relating to the status of the computing clusters and coordinate disaster recovery.

Exemplary embodiments of the present invention may therefore provide methods of disaster recovery and disaster recovery systems including a disaster recovery process to coordinate recovery of at least one computing cluster site.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary computing cluster;

FIG. 2 illustrates an exemplary computing cluster including a disaster recovery system;

FIG. 3 illustrates a plurality of exemplary computing clusters including a disaster recovery system;

FIG. 4 illustrates a flow chart of a method of disaster recovery in accordance with an exemplary embodiment;

FIG. 5 illustrates a flow chart of a method of coordinating disaster recovery in accordance with an exemplary embodiment; and

FIG. 6 illustrates an example disaster recovery scenario.

The detailed description explains the preferred embodiments of the invention, together with advantages and features, by way of example with reference to the drawings.

### DETAILED DESCRIPTION OF THE INVENTION

Hereinafter, exemplary embodiments will be described in more detail with reference to the attached drawings.

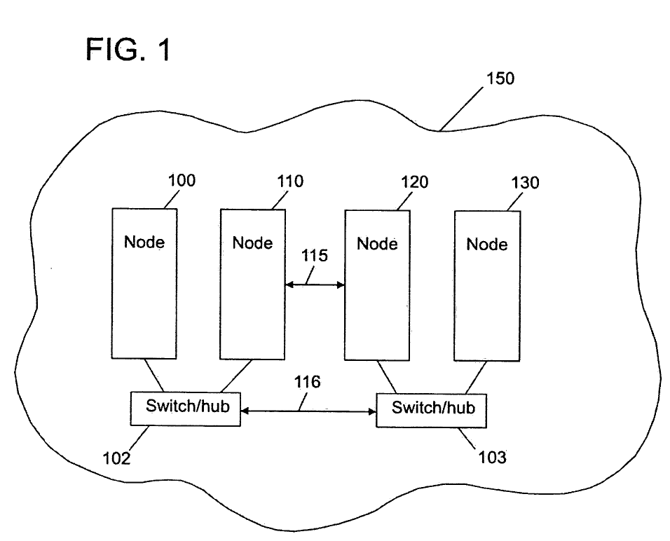

FIG. 1 illustrates an exemplary computing cluster. As depicted in FIG. 1, a computing cluster 150 may include a plurality of nodes 100, 110, 120, and 130. However, exemplary embodiments are not limited to computer clusters including any specific number of nodes. For example, more or less nodes are also applicable, and the particular number of nodes illustrated is for the purpose of explanation of exemplary embodiments only, and thus should not be construed as limiting. Additionally, each node may be a computing device, a computer server, or the like. Any computer device may be equally applicable to example embodiments. For example, the computing cluster 150 may include a plurality of computer devices rather than nodes or servers, and thus the particular type of node illustrated should not be construed as limiting.

Nodes 100, 110, 120, and 130 may be nodes or computer devices that are well known in the art. Therefore, detailed explanation of particular components or operations well known to nodes or computer devices as set forth in the present application is omitted herein for the sake of brevity.

Node 100 may be configured to communicate to node 110 through a network, such as a local area network, including a switch/hub 102. Similarly, node 120 may be configured to communicate to node 130 through a network including switch/hub 103.

Node 110 may communicate with node 120 through communication channel 115. For example, communication channel may include any suitable communication channel available, such that node 110 may direct information to node 120, and vice versa. Given the communication channel 115, node 100 may also direct information to node 120 through the network connection with switch/hub 102. In exemplary embodiments, all nodes included within computing cluster 150 may direct information to each other. Furthermore, example embodiments do not preclude the existence of additional switches, hubs, channels, or similar communication means. Therefore, according to example embodiments of the present invention, all of nodes 100, 110, 120, and 130 may be fully interconnected via switches, hubs, channels, similar communication means, or any combination thereof.

Because of the communication availability between nodes of computing cluster 150, resources of each node may be shared, and thus the available computing resources may be increased if compared with a single node. Alternatively, the resources of a portion of the nodes may be used for disaster recovery or CA of the computing cluster. For example, nodes 10 and 110 may replicate any information or data contained thereon onto nodes 120 and 130. Data replication may be implemented in a variety of ways, including hardware and software replication, and synchronous or asynchronous replication.

In exemplary embodiments, data replication may be implemented in hardware. As such, data may be copied directly from computer readable storage mediums of nodes 100 and 110 onto computer readable storage mediums of nodes 120 and 130. For example, network switch/hub 102 may direct information copied from computer readable storage mediums of nodes 100 and 110 over communication channel 116 to network switch/hub 103. Subsequently, the information copied may be replicated on computer readable storage mediums on nodes 120 and 130. In some exemplary embodiments including hardware implementations of data replication, computer readable storage mediums may be physically swapped from one node to another. For example, computer readable storage mediums may include disk, tape, compact discs, and a plurality of other mediums. It is noted that other forms of hardware data replication are also applicable.

In exemplary embodiments, data replication may be implemented in software. As such, software running on any or both of nodes 100 and 110 may direct information necessary for data replication from nodes 100 and 110 to nodes 120 and 130. For example, a software system and/or program running on nodes 100 and 110 may direct information to nodes 120 and 130 over communication channel 115. For example, if communication channel 115 is spread over a vast distance (such as through the internet) the software may direct information in the form of packets through the internet, to be replicated on nodes 120 and 130. However, other forms of software data replication are also applicable.

As data is replicated on nodes 120 and 130, nodes 120 and 130 may be initiated to assume the tasks of nodes 100 and 110 at the point of data replication.

The point of data replication, as used herein, is a term describing the state of the data stored on the replicated node, which may be used as a reference for disaster recovery. For example, if the data from one node is replicated onto a second node at a particular time, the point of data replication may represent the particular time. Similarly, other points of reference including replicated size, time, data, last entry, first entry, and/or any other suitable reference may also be used.

In the event of a disaster, nodes 120 and 130 may be initiated (or alternatively, nodes 120 and 130 may already be active, and any workload of nodes 100 and 110 may be initiated on nodes 120 and 130). Any processes or programs which are stored on the nodes 120 and 130 may be booted, such that the responsibilities and/or tasks associated with nodes 100 and 110 may be assumed by nodes 120 and 130. Alternatively, the responsibilities and/or tasks associated with nodes 100 and 110 may be assumed by nodes 120 and 130 in a planned fashion (i.e., not in the event of disaster). Such a switch of responsibilities may be planned in accordance with a maintenance schedule, upgrade schedule, or for any operation which may be desired.

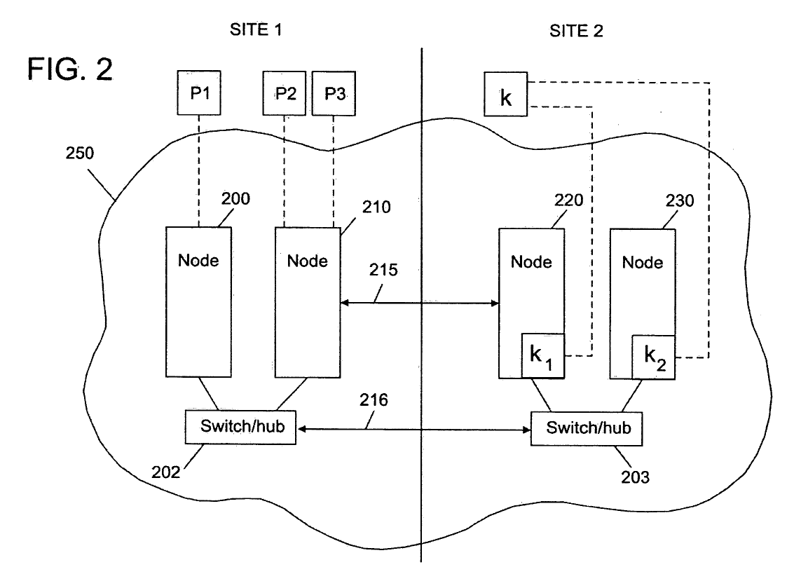

It is appreciated that as described above, nodes 120 and 130 may assume control of responsibilities and/or tasks associated with nodes 100 and 110. Hereinafter, a computing cluster including a disaster recovery system which is configured to recover from a disaster (whether a planned take-over or event of disaster) is described with reference to FIG. 2.

FIG. 2 illustrates an exemplary computing cluster including a disaster recovery system. As illustrated in FIG. 2, computing cluster 250 may include a plurality of nodes. Computing cluster 250 may be similar or substantially similar to computing cluster 150 described above with reference to FIG. 1. For example, the plurality of nodes 200, 210, 220, and 230 may share resources, replicate data, and/or perform similar tasks as described above with reference to FIG. 1. Therefore, a detailed description of the computing cluster 250 is omitted herein for the sake of brevity.

As further illustrated in FIG. 2, computing cluster 250 is divided into two portions (computing cluster sites) denoted “SITE 1” and “SITE 2”. In exemplary embodiments, the division may be a geographical division or a logical division.

For example, a geographical division may include SITE 1 at a different geographical location than SITE 2. Typically, a geographical distance of under 100 fiber kilometers is considered a metropolitan distance, and a geographical distance or more than 100 fiber kilometers is considered a wide-area or unlimited distance. Generally, a fiber kilometer may be defined as the distance a length of optical fiber travels underground. Therefore, 100 fiber kilometers may represent a length of buried optical fiber displaced 100 kilometers. All such distances are intended to be applicable to exemplary embodiments. Furthermore, it is understood that in communication between nodes, there may be a delay introduced by the distance between nodes. For example, nodes separated by 100 fiber kilometers may generally be affected by a one-millisecond delay (e.g., metropolitan distance separation includes a reduced delay compared to wide-area separations). Therefore, there may be about one millisecond of delay introduced for every 100-fiber kilometers between nodes.

With further regards to geographical division, if computing cluster sites are separated by metropolitan distances, each computing cluster site may be a sub-component of one computing cluster spanning the computing cluster sites (i.e. one spanned cluster). Furthermore, given the reduced delay as noted above, clusters spanning metropolitan distances may employ synchronous data replication. In contrast, if wide-area distances separate computing cluster sites, each computing cluster site may be a separate computing cluster. Furthermore, given the delay introduced at wide-area distances, data may be replicated asynchronously.

With regards to a logical division, for example, a logical division may denote that the nodes at SITE 2 are used for disaster recovery purposes and/or data replication purposes. Such is a logical division of the nodes. As shown in FIG. 2, nodes 200 and 210 may be located in SITE 1 and nodes 220 and 230 may be located in SITE 2.

As further illustrated in FIG. 2, node 200 may be configured to support primary process P1. Primary process P1 may be any process and/or computer program. For example, included herein for illustrative purposes only and not to be construed as limiting, primary process P1 may be a web application process or similar application process.

Node 210 may be configured to support primary processes P2 and P3. Primary processes P2 and P3 may be similar to primary process P1, or may be entirely different processes altogether. For example, included herein for illustrative purposes only, primary processes P2 and P3 may be database processes or data acquisition processes for use with a web application, or any other suitable processes.

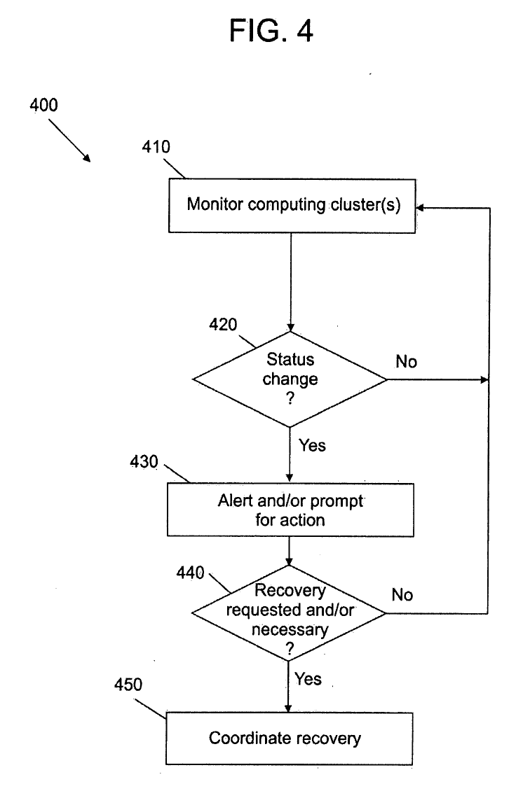

As also illustrated in FIG. 2, a disaster recovery process k may be processed at SITE 2. For example, either of nodes 220 or 230 may support disaster recovery process k. Alternatively, another node (not illustrated) may support disaster recovery process k. Disaster recovery process k may be a process including steps and/or operations to coordinate disaster recovery of the nodes at SITE 1 onto SITE 2. For example, in the event of a disaster or a planned site take-over (i.e., for information management, upgrade, maintenance, or other purposes) disaster recovery process k may direct nodes 220 and 230 to assume the responsibilities and/or tasks associated with nodes 200 and 210. Disaster recovery process k is described further in this detailed description with reference to FIG. 4.

Nodes 220 and 230 may have available resources not used by the disaster recovery system illustrated. For example, nodes 220 and 230 may include extra processors, data storage, memory, and other resources not necessary for data replication and/or data recovery monitoring. Therefore, the extra resources may remain in a stand-by state or other similar inactive states until necessary. For example, a computer device mainboard may be equipped with 15 microprocessors. Each microprocessor may have enough resources to support a fixed number of processes. If there are only a few processes being supported (e.g., data replication) each unused microprocessor may be placed in a stand-by or inactive state. In the event of a disaster, or in the event the additional resources are needed (e.g., to support primary processes described above and site switch) the inactive microprocessors may be activated to provide additional resources.

Node 220 may be configured to process disaster recovery agent k1 and node 230 may be configured to process disaster recovery agent k2. Disaster recovery agents k1 and k2 may be processes associated with monitoring of nodes 200 and 210. As shown in FIG. 2, disaster recovery agents k1 and k2 may communicate with disaster recovery process k. Disaster recovery agents k1 and k2 may direct monitoring information regarding the status of nodes 200 and 210 to disaster recovery process k, such that a disaster may be detected.

For example, given the communication available to nodes in computing clusters, processes or applications on nodes may communicate regularly with other applications within the cluster. Therefore, it is understood that disaster recovery process k may employ a communications protocol such that it may communicate directly with disaster recovery agents k1 and k2. During operation, disaster recovery agents k1 and k2 may direct information to disaster recovery process k. Such information may be in the form of data packets, overhead messages, system messages, or other suitable forms where information may be transmitted form one process to another. In an exemplary embodiment, disaster recovery agents k1 and k2 communicate with disaster recovery process k over s secure communication protocol.

With regards to monitoring using disaster recovery agents k1 and k2, as nodes 200 and 210 may communicate with nodes 220 and 230, disaster recovery agents k1 and k2 may monitor the activity of nodes 200 and 210. Furthermore, as data replication is employed between nodes 200 and 210 and nodes 220 and 230, disaster recovery agents k1 and k2 may direct information pertaining to the state and/or status of data replication to disaster recovery process k. In exemplary embodiments, nodes 200 and 210 may be configured to transmit a steady state heartbeat signal to nodes 220 and 230, for example, over the network hub/switch 202 or communication channel 215. The steady state heartbeat signal may be an empty packet, data packet, overhead communication signal, or any other suitable signal. Alternatively, as described above, because data replication and other communication may be employed in computing cluster 250, disaster recovery agents k1 and k2, may simply search for inactivity or lack of communication as status of nodes 200 and 210, and direct the status to disaster recovery process k. In this manner, disaster recovery process k may monitor the status of computing cluster 250, and may be able to detect disasters or impairments of nodes 200 and 210. Additionally, disaster recovery process k may detect impairments of nodes 220 and 230 (i.e., lack of status update or status from agents k1 and k2).

For example, nodes within a computing cluster may employ a known or standard communication protocol. Such a protocol may use packets to transmit information from one node to another. In this example, in order to monitor nodes, disaster recovery agents k1 and k2 may receive packets indicating nodes are in an active or inactive state. In another example, nodes within a computing cluster may be interconnected with communication channels. Such communication channels may support steady state signaling or messaging. In this example, disaster recovery agents k1 and k2 may receive messages or signals representing an active state of a particular node. Furthermore, the lack of a steady state signal may serve to indicate a particular node is inactive or impaired. This information may be transmitted to disaster recovery process k, such that the status of nodes may be readily interpreted. Other communication protocols are also applicable to exemplary embodiments and thus the examples given above should be considered illustrative only, and not limiting.

Through monitoring the nodes within cluster 250, disaster recovery process k may determine if a disaster has occurred, or whether SITE 1 is to be taken over (e.g., for maintenance, etc.). In the event of a disaster or site takeover, disaster recovery process k may coordinate disaster recovery using communication within computing cluster 250.

Therefore, as discussed above and according to exemplary embodiments, a computing cluster including a disaster recovery system is disclosed. However, exemplary embodiments are not limited to single or individual computing clusters. For example, a plurality of computing clusters may include a disaster recovery system, as is further described below.

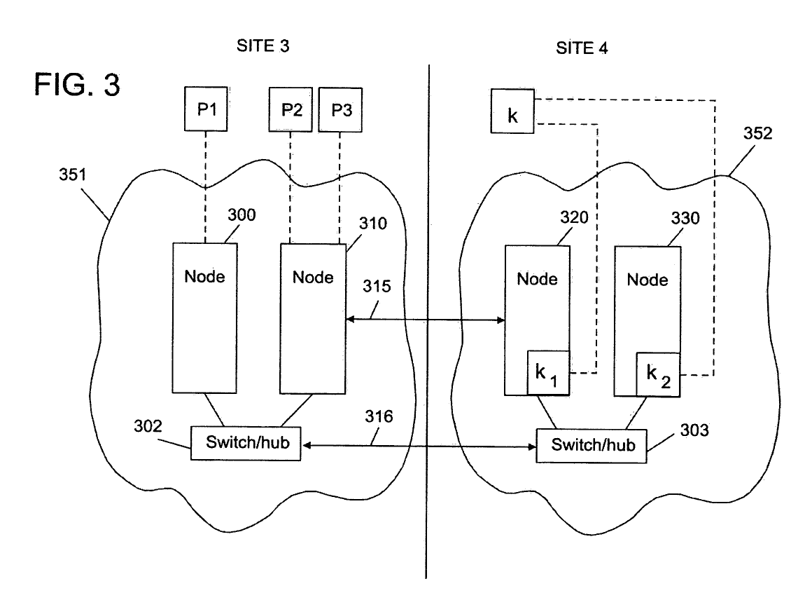

FIG. 3 illustrates a plurality of exemplary computing clusters including a disaster recovery system. As illustrated in FIG. 3, the plurality of computing clusters 351 and 352 may include a plurality of nodes. Computing clusters 351 and 352 may be similar or substantially similar to computing cluster 150 described above with reference to FIG. 1. For example, the plurality of nodes 300, 310, 320, and 330 may share resources, replicate data, and/or perform similar tasks as described above with reference to FIG. 1. Therefore, a detailed description of the computing clusters 351 and 352 is omitted herein for the sake of brevity, save notable differences that are described below.

Computing clusters 351 and 352 are divided onto “SITE 3” and “SITE 4”. Nodes 300 and 310 are located within SITE 3, and nodes 320 and 330 are located within SITE 4. Therefore, computing cluster 351 is located on SITE 3, and computing cluster 352 is located on SITE 4. However, as communications channels exist between computing clusters 351 and 352, data may be replicated from SITE 3 to SITE 4, and resources may be shared from SITE 3 to SITE 4. For example, data may be copied or transmitted from nodes 300 and 310 to nodes 320 and 330 as described hereinbefore. Similarly, computing servers 320 and 330 may store the replicated data for disaster recovery.

As further illustrated in FIG. 3, nodes 300 and 310 are configured to support primary processes P1, P2 and P3, respectively. Primary processes P1, P2, and P3 may be similar to, or substantially similar to primary processes P1, P2, and P3 as described above with reference to FIG. 2. FIG. 3 further illustrates disaster recovery process k processed in SITE 4. Disaster recovery process k may be similar to, or substantially similar to, disaster recovery process k described above with reference to FIG. 2, and may be supported by either of nodes 320 or 330, or another node in SITE 4 (not illustrated). Furthermore, disaster recovery agents k1 and k2 may be substantially similar to disaster recovery agents k1 and k2 described above with reference to FIG. 2.

Therefore, disaster recovery process k may monitor computing clusters 351 and 352, and may detect a potential disaster or impairment of nodes 300, 310, 320, and/or 330. As such, a disaster recovery system, employed by a plurality of computing clusters is disclosed. Hereinafter, method of disaster recovery is described with reference to FIG. 4.

FIG. 4 illustrates a flow chart of a method of disaster recovery in accordance with an exemplary embodiment. As illustrated in FIG. 4, a method of disaster recovery 400 may include monitoring computer cluster(s) in step 410. For example, a disaster recovery process (e.g., disaster recovery process k illustrated in FIG. 2 or 3) may receive information regarding the status of nodes located in a cluster, or across multiple clusters.

As further illustrated in FIG. 4, the disaster recovery method may include determining whether there is a status change at step 420. For example, a disaster recovery process may interpret information gathered during monitoring the computer cluster(s) to determine if the status and/or state of nodes in the cluster(s) has changed. Additionally, the disaster recovery process may interpret the information to determine the current status of the computing cluster(s) being monitored. In exemplary embodiments, a disaster recovery process may interpret the information to determine whether there is no heartbeat (i.e., steady state heart beat signal or similar signal), data synchronization failures, or suspension of data replication.

In determining whether there is no heartbeat, the disaster recovery process may receive information from disaster recovery agents within a cluster or a plurality of clusters that are monitored. As the disaster recovery agents monitor activity of the cluster(s), the information sent to the disaster recovery process may include status of heartbeats of nodes within the cluster(s). Therefore, the disaster recovery process may determine if there is a lack of heartbeat in a cluster (or across a plurality of clusters).

In determining if there is a data synchronization failure, a disaster recovery process may receive information from disaster recovery agents within a cluster. The disaster recovery agents may monitor communications within the cluster. If there is a failure in data synchronization, or if data transmittal fails, messages or information pertaining to the failure may be sent to the disaster recovery process. Therefore, the disaster recovery process may determine if there is a data synchronization failure.

In determining whether data replication has suspended, a disaster recovery process may receive information from disaster recovery agents within a cluster. The disaster recovery agents may monitor the status of data replication between sites. In there is a halt in replication or suspension of data transmittal for replication, the disaster recovery agents may transmit this information to the disaster recovery process. Therefore, the disaster recovery process may determine if data replication has suspended.

As such, a disaster recovery process may determine if the status of the computing cluster(s) have changed. In the status of the computing cluster(s) has not changed, there may not be a recovery required and/or requested for the cluster(s), and monitoring of the cluster(s) may resume/continue.

If the status of the computing cluster(s) has changed, au alert may be issued and/or a prompt for user input may be issued at step 430. For example, if there has been a change in activity of a computer cluster being monitored (e.g., a first cluster), a prompt for recovery action may be output for user response. The prompt may include information pertaining to the change in activity, and possible sources of the change. A user (e.g., a site or server administrator) may input a request to recover the first cluster (i.e., using data replicated on a second cluster, or other active nodes in the first cluster). Alternatively, if there is a lack of activity, the prompt may include information regarding a potential disaster. In yet another alternative, the prompt may simply be issued at regular intervals to allow the possibility of service or maintenance, or a user may simply enter a maintenance request without any prompt being issued. For example, a site takeover for maintenance (i.e., a planned site takeover) may be similar to, or substantially similar to, a disaster recovery. However, it should be noted that these examples of cluster monitoring and prompts are for illustrative purposes only. Any combination or alteration of the above mentioned examples is intended to be applicable to exemplary embodiments.

If user input received does not indicate recovery is necessary and/or requested, monitoring of the computing cluster(s) may resume/continue. Alternatively, if user input does indicate recovery is necessary and/or requested, the disaster recovery process may coordinate recovery in step 450.

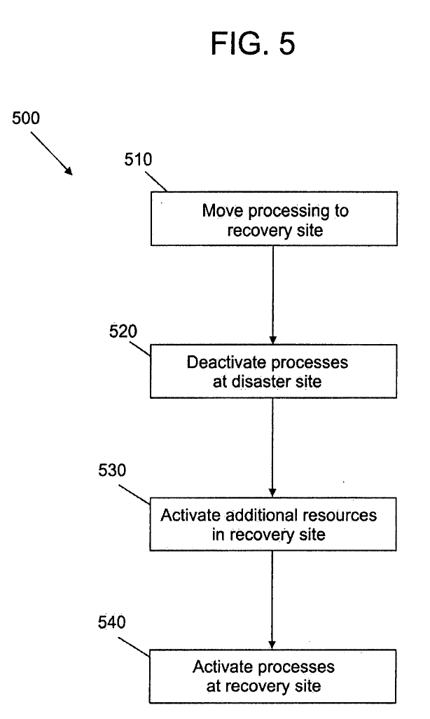

Hereinafter a method of coordinating recovery, as noted above in FIG. 4, step 450, is described in detail with reference to FIG. 5.

FIG. 5 illustrates a low chart of a method of coordinating disaster recovery in accordance with an exemplary embodiment. The method of coordinating disaster recovery 500 may be performed by a disaster recovery process and/or agents (e.g., disaster recovery process k and/or agents k1 and k2 of FIG. 2 or 3). As illustrated in FIG. 5, in the event of a disaster or planned site takeover, the disaster recovery process may move processing to a recovery site. A recovery site is a term describing a site, cluster, and/or portion of a cluster including data replicated from a disaster site. For example, SITE 2 of FIG. 2, and SITE 4 of FIG. 3 may be described as recovery sites. A disaster site is a term describing a site, cluster, and/or portion of a cluster to be recovered (e.g., replicated data, re-launch of workload on another site, etc.). For example, SITE 1 of FIG. 2, and SITE 3 of FIG. 3 may be described as disaster sites.

As further illustrated in FIG. 5, processes at the disaster site are deactivated at step 520. In an exemplary embodiment, many tasks and/or operations are to be assumed by a second site, thus the tasks or operations of the disaster site are not running simultaneously. However, the opposite may also be true. For example, in some systems it may not be necessary to deactivate a disaster site before assuming control on a second site, thus, this step may be omitted if appropriate.

FIG. 5 also illustrates activating additional resources in the recovery site at step 530. As described above with reference to FIGS. 2 and 3, there may be additional resources in a recovery site (e.g., SITE 2 of FIG. 2, and SITE 4 of FIG. 3) that are unused or in a stand-by state. For example, a node in a cluster of SITE 2 may have additional microprocessors in an inactive state. It may be necessary to activate these additional resources such that the recovery site has similar resources available as are available to the disaster site. Therefore, if additional resources in the recovery site are activated, the recovery site may have sufficient resources to perform a site-takeover and/or assume control of the tasks of the disaster site. Alternatively, there may not be a need for additional resources if the disaster site is to assume control. Therefore, this step may be omitted if appropriate.

FIG. 5 further illustrates activating processes at the recovery site at step 540. For example, with reference to FIG. 2, primary processes P1, P2, and P3 are supported by nodes 200 and 210, respectively. In the event of a disaster (or planned site takeover) nodes 220 and 230 may be activated and may begin to support primary processes P1, P2, and P3. For example, because data is replicated from SITE 1 onto SITE 2, SITE 2 has available information (e.g., images or other such information) of primary processes P1, P2, and P3. Therefore, P1, P2, and P3 may be activated at SITE 2 such that SITE 2 may perform the tasks of SITE 1. In this manner, the nodes at SITE 2 may assume control over the processes at SITE 1.

Because activation of processes at the recovery site is initiated by the disaster recovery process, a single point of control is used. For example, any processes and/or tasks of the disaster site are initiated from a single point of control. Therefore, it may be appreciated that time-lapse discrepancies, boot-time discrepancies, and/or other time-related issues may be reduced if compared to conventional methods. Therefore, as disclosed herein, exemplary embodiments provide methods of disaster recovery including coordination of disaster recovery of at least one computing cluster.

In order to increase understanding of the exemplary embodiments set forth above, the following example disaster recovery scenario is explained in detail. This example scenario is for the purpose of illustration only, and is not limiting of exemplary embodiments.

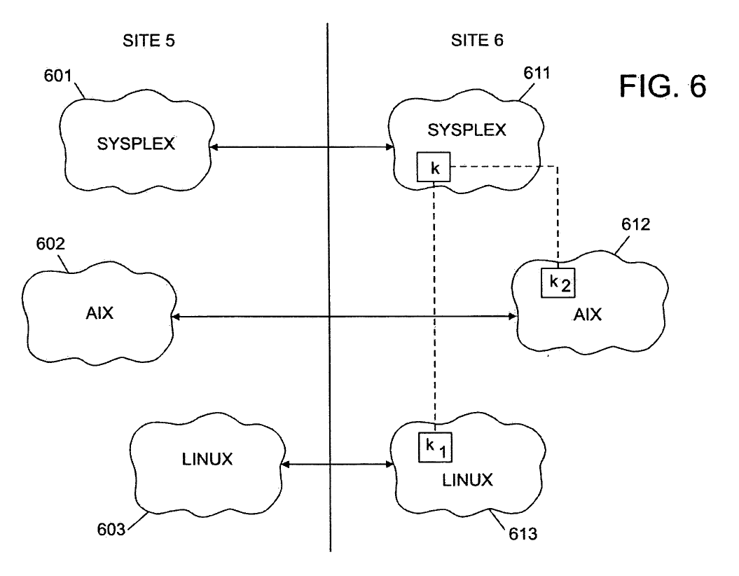

FIG. 6 illustrates an example disaster recovery scenario. As shown in FIG. 6, SITE 5 (disaster site) includes three computing clusters. Each computing cluster is based on a different platform. Cluster 601 is a PARALLEL SYSPLEX cluster running Z/OS. Cluster 602 is an AIX cluster. Cluster 603 is a LINUX cluster.

In SITE 6 (recovery site), there are also three clusters. Cluster 611 is a PARALLEL SYSPLEX cluster and supports the disaster recovery process k. Cluster 612 is an AIX cluster and supports disaster recovery agent k1. Cluster 613 is a LINUX cluster and supports disaster recovery agent k2. Furthermore, data replication is employed between cluster 601 and 611, clusters 602 and 612, and clusters 603 and 613. The data replication may be synchronized volume replication, or another form of replication where data is made available to the recovery site necessary for taking over control of tasks of the disaster site. Therefore, the information necessary to assume the tasks of SITE 5 is replicated in SITE 6.

Furthermore, disaster recovery agents k1 and k2 monitor steady-state heartbeats of nodes within clusters 602 and 603. Furthermore, as disaster recovery process k is supported by cluster 611, disaster recovery process k may monitor data replication between clusters 601 and 611.

In an example disaster scenario, the heartbeats of clusters 602 and 603 are inactive. Disaster recovery agents k1 and k2 transmit information (e.g., via GDPS messaging, etc.) pertaining to the status of the heartbeats to disaster recovery process k. In response, disaster recovery process k prompts for user input. The prompt includes information regarding the inactive heartbeats of clusters 602 and 603. Upon receipt of user input to recover SITE 5, the disaster recovery process k coordinates recovery.

For example, the disaster recovery process k may execute a script or workflow on a node of cluster 611. The script or workflow may contain instructions to coordinate disaster recovery. For example, the script or workflow may contain application specific instructions for executing the method of FIG. 5. Therefore, recovery of SITE 5 may be coordinated such that clusters 611, 612, and 613 begin assuming the responsibilities of SITE 5 from a single point of control, disaster recovery process k. The coordination of recovery may be based on user input from the recovery site.

The capabilities of the present invention can be implemented in software, firmware, hardware, or some combination thereof.

As one example, one or more aspects of the present invention may be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A disaster recovery system, comprising:
a computer processor; and
a disaster recovery process residing on the computer processor, the disaster recovery process having instructions to:
monitor at least one computing cluster site;
communicate monitoring events regarding the at least cone computing cluster site with a second computing cluster site;
generate alerts responsive to the monitoring events on the second computing cluster site regarding potential disasters; and
coordinate recovery of the at least one computing cluster site onto the second computing cluster site in the event of a disaster.

2. The disaster recovery system of claim 1, wherein the computer processor resides in the second computing cluster site.

3. The disaster recovery system of claim 1, wherein the monitoring events include at least one of a steady state heartbeat representing the status of the at least one computing cluster site, the status of the second computing cluster site, and flags representing a potential disaster.

4. The disaster recovery system of claim 1, wherein the disaster recover process further includes instructions to resume processing activities of the at least one computing cluster site on the second computing cluster site with data replicated on the second computing cluster site from the at least one computing cluster site.

5. The disaster recovery system of claim 1, wherein the at least one computing cluster site and the second computing cluster site are sub-components of one spanned computing cluster.

6. The disaster recovery system of claim 1, wherein the at least one computing cluster site and the second computing cluster site are separate computing clusters.

7. A method of disaster recovery of at least one computing cluster site, the method comprising:
receiving monitoring events regarding the at least one computing cluster site;
generating alerts responsive to the monitoring events regarding potential disasters;
coordinating recovery of the at least one computing cluster based on the alerts.

8. The method of claim 7, wherein the monitoring events include at least one of a steady state heartbeat representing the status of the at least one computing cluster site, the status of a second computing cluster site, and flags representing a potential disaster.

9. The method of claim 7, further comprising:
replicating data from the at least one computing cluster site.

10. The method of claim 7, wherein the generating alerts includes:
interpreting monitoring events to determine whether disaster recovery is necessary; and
prompting for user input based on the interpretation.

11. The method of claim 10, further comprising:
receiving user input based on the alerts; and
coordinating disaster recovery based on the user input.

12. The method of claim 7, wherein the coordinating recovery is based on user input responsive to the alerts.

13. The method of claim 12, wherein the user input responsive to the alerts includes user input to recover the at least one computing cluster site based on a planned site takeover.

14. The method of claim 12, wherein the user input responsive to the alerts includes user input to recover the at least one computing cluster site based on maintenance of the at least one computing cluster site.

15. The method of claim 7, wherein the receiving monitoring events, the generating alerts, and the coordinating recovery are performed on a second computer cluster site.

16. The method of claim 15, wherein the at least one computing cluster site is geographically located within one hundred kilometers of the second computing cluster site.

17. The method of claim 15, wherein the at least one computing cluster site is geographically located more than one hundred fiber kilometers from the second computing cluster site.

18. A method of disaster recovery of at least one computing cluster site, the method comprising:
sending monitoring events regarding the at least one computing cluster site;
transmitting data from the at least one computing cluster site for disaster recovery based on the monitoring events; and
ceasing processing activities.

19. The method of claim 18, wherein the monitoring events includes at least one of a steady state heartbeat representing the status of the at least one computing cluster site and flags representing a potential disaster.

20. The method of claim 18, wherein the transmitted data is replicated on a second computing cluster site geographically separated from the at least one computing cluster site.

21. The method of claim 18, further comprising deferring the processing activities to a second computing cluster site having images of the processing activities of the at least one computing cluster site.
